(19) United States
(12) Patent Application Publication
(10) Pub. No.: US 2013/0078092 A1
(43) Pub. Date: Mar. 28, 2013

(54) DEVICE AND METHOD FOR CONTROLLING ROTATION SPEED OF A VERTICAL AXIS WINDMILL BY USING ROTATING CENTRIFUGAL FORCE OF ROTOR BLADES

(71) Applicants: Cheng-Keng CHEN, Taipei (TW); Ming-Guo CHEN, Taipei (TW)

(72) Inventors: Cheng-Keng CHEN, Taipei (TW); Ming-Guo CHEN, Taipei (TW)

(21) Appl. No.: 13/620,705

(22) Filed: Sep. 15, 2012

(30) Foreign Application Priority Data
Sep. 22, 2011 (TW) 100134076

(51) Int. Cl. F03D 3/00; F03D 11/00

(52) U.S. Cl. 416/1; 416/32

(57) ABSTRACT

A method for controlling rotation speed of a vertical axis windmill by using rotating centrifugal force of blades comprises the steps of a. forming the rotor blades; b. rotation of the rotor blades; and c. lift control. A device for controlling rotation speed of the vertical axis windmill comprises a plate mounted on each of the rotor blades, then an elastic lift control device provides an elasticity to press the plate against the rotor blades, and the centrifugal force produced by the rotation of the vertical axis windmill counteracts the elasticity, so as to create an automatically adjustable, passively controlled and durable windmill.

### BACKGROUND OF THE INVENTION

1. Field of the Invention

The present invention relates to a device and method for controlling rotation speed of a vertical axis windmill, and more particularly device and method for controlling rotation speed of a vertical axis windmill by using rotating centrifugal force of rotor blades.

2. Description of the Prior Art

Wind power is currently one of the common and important alternative energy, and many wind turbine techniques have been publicly disclosed. Existing wind generators have been able to provide a considerable amount of energy, but they still suffer from the problem that the rotation speed of the rotary shaft is too fast, which not only is likely to damage the wind turbine, but also (in sever cases) may cause disintegration of the wind turbine.

To solve the above problems, some of the wind turbines have been additionally provided with a brake device. However, the brake device must always be maintained in the actuated position, causing excessive wear to the brake device, and therefore the brake device needs to be replaced frequently, otherwise, too fast rotation speed will cause damage to the wind turbine. Hence, an overspeed spoiler for vertical axis wind turbine was developed, as shown in FIGS. 1A and 1B, wherein the wind turbine comprises a plurality of rotor blades 10, each rotor blade 10 includes a round leading edge 101 and a sharp trailing edge 102, and a direction extending from the leading edge 101 to the trailing edge 102 is defined as X. The overspeed spoiler 11 is mounted on a pivot 111 at the trailing edge 102 and made up of two flat plate-like portions 112 and 113 with an angle therebetween.

The portion 113 can be provided with a balance weight 114 as shown in FIG. 1A, or the portion 112 has a curvature to conform with the contour of the leading edge 101 of the rotor blade 10, as shown in FIG. 1B, so that, at normal wind and rotor speeds, the overspeed spoiler 11 maintains a position as shown with section positioned close (or flush) to the surface of the rotor blade 10. Portion 113 extends rearwardly in the direction X. When the rotor overspeeds, due to centrifugal action involved the overspeed spoiler 11 rotates on the pivot 111 to take up a new position with the portion 113 generally normal to the air flow (the direction X) and the portion 112 moving away from the surface of the rotor blade 10, so that the open spoiler 11 causes much increased drag slowing down the rotor until the speed has decreased to where the spoiler 11 returns to the closed position.

However, due to centrifugal action involved the rotor blade 10 keeps changing the direction of the centrifugal force, as a result, the spoiler 11 will keep rotating between opened and closed positions, namely the relative position between the two portions 113 and 112 is always changing, which will not only cause fatigue of the spoiler 11, but the effect of slowing down the rotor speed is also limited. Furthermore, when the spoiler 11 is counteracting the centrifugal force and slowing down the rotation speed, the maximum torque applied to the spoiler 11 is located at the pivot 111 which is located at the trailing edge 102 of the rotor blade 10, plus the material fatigue problem, and the pivotal angles of the two portions 112 and 113 are about 90 degrees. All these matters will produce too much friction on the pivot 111, resulting in weak structural strength.

The present invention has arisen to mitigate and/or obviate the afore-described disadvantages.

### SUMMARY OF THE INVENTION

The primary objective of the present invention is to provide a device and method for controlling rotation speed of a vertical axis windmill by using rotating centrifugal force of rotor blades, wherein the windmill is automatically adjustable, passively controlled and durable.

To achieve the above objective, a method for controlling rotation speed of a vertical axis windmill by using rotating centrifugal force of rotor blades, in accordance with the present invention comprises the following steps:

a. mounting a plate and a lift control device on each of the rotor blades in such a manner that a pivot at a pivot end of the plate is pivoted to a leading edge of each of the rotor blades and arranged in parallel to a rotary shaft of the vertical axis windmill, a free end of the plate extends toward a trailing edge of each of the rotor blades, and the lift control device provides an elasticity to press the plate against each of the rotor blades;

b. the rotary shaft of the vertical axis windmill rotating the rotor blade to produce a centrifugal force on the plate to push the plate against the lift control device, and the elasticity counteracting the centrifugal force; and

c. increasing the rotation speed of the rotary shaft of the vertical axis windmill until the centrifugal force is larger than the elasticity, so that the free end of the plate will pivot away from the rotor blades to change a lift of the rotor blades and break a rotation inertia of the rotor blades, and consequently slowing down the rotation speed of the rotary shaft of the vertical axis windmill.

A device for controlling rotation speed of a vertical axis windmill by using rotating centrifugal force of rotor blades, the vertical axis windmill comprises a rotary shaft and a plurality of the rotor blades mounted on the rotary shaft, each of the rotor blades is provided at a leading edge thereof with a plate and a lift control device.

Each of the rotor blades includes the leading edge and a trailing edge, between the leading edge and the trailing edge of each of the rotor blades are an inner surface located toward the rotary shaft and an outer surface opposite the inner surface.

The plate is mounted on the outer surface of the respective rotor blades and includes a pivot end and a free end, the pivot end is pivoted to the leading edge of the rotor blades via a pivot, and the free end extends rearward toward the trailing edge;

The lift control device includes two elastic pressing pieces disposed at two ends of the pivot, and each of the elastic pressing pieces includes a fixing portion fixed at the leading edge of each of the rotor blades and a pressing portion extending rearward toward the trailing edge, the pressing portions of the two elastic pressing pieces have an elasticity to press against the free end of the plate.

The vertical axis windmill rotates to provide a centrifugal force to the plate, and when the centrifugal force is larger than the elasticity, the free end of the plate will pivot away from a surface of the rotor blades along with the pivot, so that a lift and rotation inertia of the rotor blades will be changed to slow down the rotation speed of the rotary shaft of the vertical axis windmill.

### BRIEF DESCRIPTION OF THE DRAWINGS

FIG. 1A is a cross sectional view showing that a conventional lift control device disposed at the rear end of the rotor blade of a vertical axis windmill;

FIG. 1B is a cross sectional view showing that a conventional lift control device disposed at the front end of the rotor blade of a vertical axis windmill;

FIG. 2 is a perspective view of the present invention showing that the lift control devices are mounted on the egg beater type windmill;

FIG. 3 is an enlarged view of the lift control device of FIG. 2;

FIG. 4 is a cross sectional view taken along the line 4-4 of FIG. 3;

FIG. 5 is a cross sectional view taken along the line 5-5 of FIG. 3;

FIG. 6 is a cross sectional view showing that the lift control device of the present invention is pushed away from the rotor blade by the rotation centrifugal force;

FIG. 7 is a perspective view of the present invention showing that the lift control devices are mounted on the H type windmill;

FIG. 8A is an illustrative view of the aerofoil cross section of the rotor blade when the plate of the lift control device of the present invention is pressed against the rotor blade;

FIG. 8B is an illustrative view of the aerofoil cross section of the rotor blade when the plate of the lift control device of the present invention is pivoted 5 degrees away the rotor blade;

FIG. 8C is an illustrative view of the aerofoil cross section of the rotor blade when the plate of the lift control device of the present invention is pivoted 10 degrees away the rotor blade;

FIG. 8D is an illustrative view of the aerofoil cross section of the rotor blade when the plate of the lift control device of the present invention is pivoted 15 degrees away the rotor blade;

FIG. 9A is a data diagram showing the lift coefficient (Cl) and angle of attack (α) of the rotor blade;

FIG. 9B is a data diagram showing the drag coefficient (Cd) and the angle of attack (α) of the rotor blade;

FIG. 9C is a data diagram showing the torque and the angle of attack of the rotor blade;

FIG. 10 showing another embodiment of the lift control device of the present invention;

FIG. 11 is a cross sectional view of the lift control device of FIG. 10;

FIG. 12 showing another embodiment of the lift control device of the present invention;

FIG. 13 is a side view of the lift control device of FIG. 12;

FIG. 14 is a cross sectional view of the lift control device of FIG. 12;

FIG. 15 is a cross sectional view of another embodiment of the lift control device of the present invention; and

FIG. 16 is an operational view of the lift control device shown in FIG. 15.

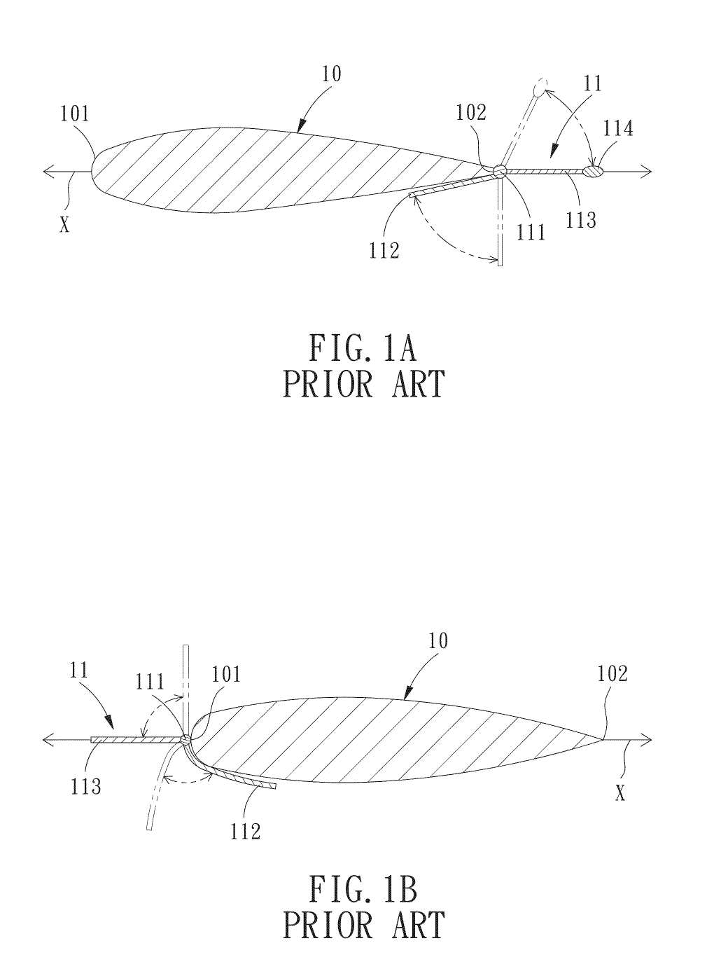

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

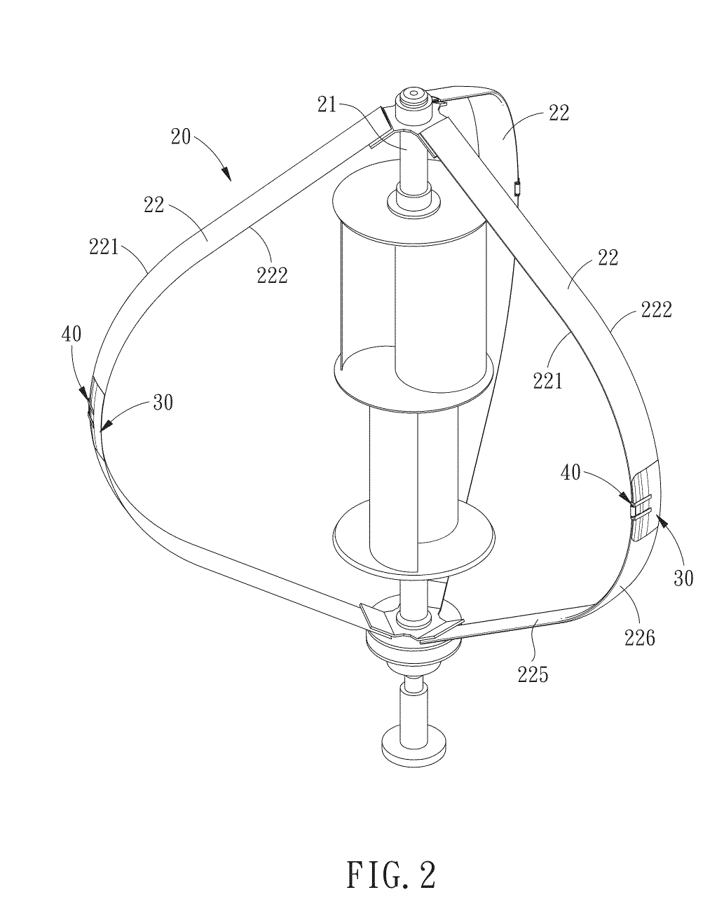

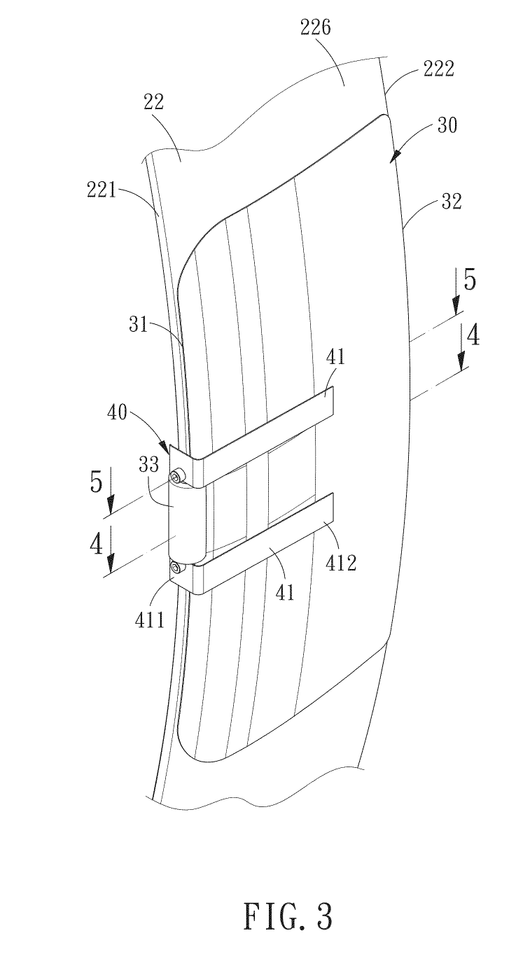

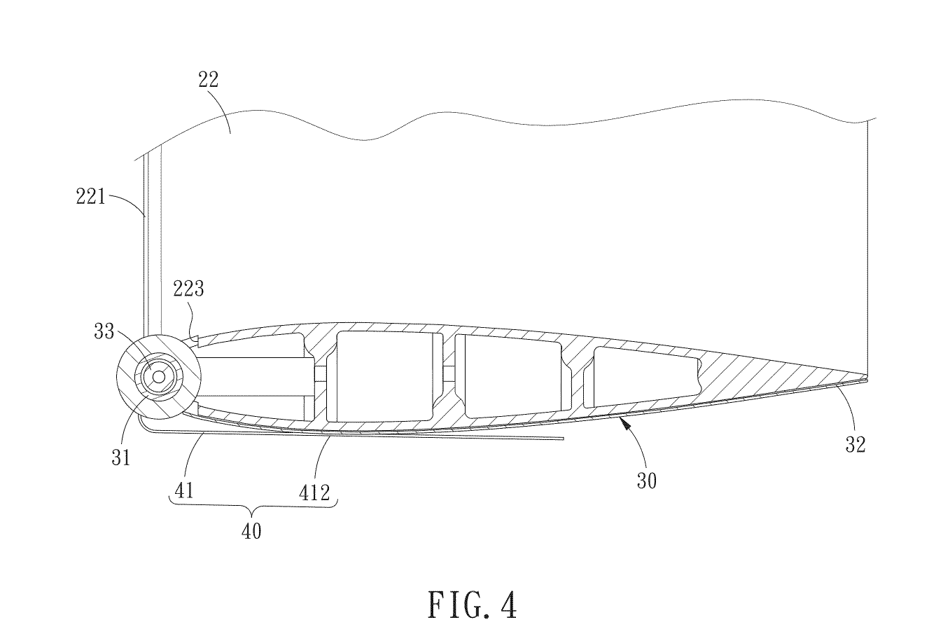

Referring to FIGS. 2-5, a device for controlling rotation speed of a vertical axis windmill by using rotating centrifugal force of rotor blades in accordance with a preferred embodiment of the present invention is shown, wherein the vertical axis windmill 20 comprises a rotary shaft 21 and a plurality of rotor blades 22 mounted on the rotary shaft 21. Each of the rotor blades 22 is provided at a leading edge 221 with a plate 30 and a lift control device 40.

Each of the rotor blades 22 is provided at two longitudinal sides thereof with the leading edge 221 with an obtuse aerofoil cross section and a trailing edge 222 with an acute aerofoil cross section, respectively. Between the leading edge 221 and the trailing edge 222 of each of the rotor blades 22 are an inner surface 225 located toward the rotary shaft 21 and an outer surface 226 opposite the inner surface 225.

Each of the plates 30 is mounted on the outer surface 226 of the respective rotor blades 22 and includes a pivot end 31 and a free end 32. The pivot end 31 is pivoted to the leading edge 221 of the rotor blades 22 via a pivot 33, and the free end 32 extends rearward toward the trailing edge 222. In this embodiment, the leading edge 221 of each of the rotor blades 22 is provided with a receiving cavity 223 which is located at a position in parallel with the rotary shaft 21, the pivot 33 is inserted in the receiving cavity 223 and arranged in parallel with the rotary shaft 21, and the pivot end 31 of each of the plates 30 takes the form of a hollow sleeve structure pivotally sleeved on the pivot 33.

Each of the lift control devices 40 includes two elastic pressing pieces 41 disposed at two ends of the pivot 33, and each of the elastic pressing pieces 41 is made of spring steel and includes a fixing portion 411 fixed at the leading edge 221 of each of the rotor blades 22 and a pressing portion 412 extending rearward toward the trailing edge 222 of each of the rotor blades 22. The pressing portions 412 of the two elastic pressing pieces 41 have an elasticity Fₚ to press the free ends 32 of the corresponding plates 30.

In this embodiment, each of the rotor blades 22 is provided with two locking holes 224 located two ends of the pivot 33, then two fasteners 413 are inserted through the fixing portions 411 of the two elastic pressing pieces 41 of each of the lift control devices 40 and screwed into the two locking holes 224.

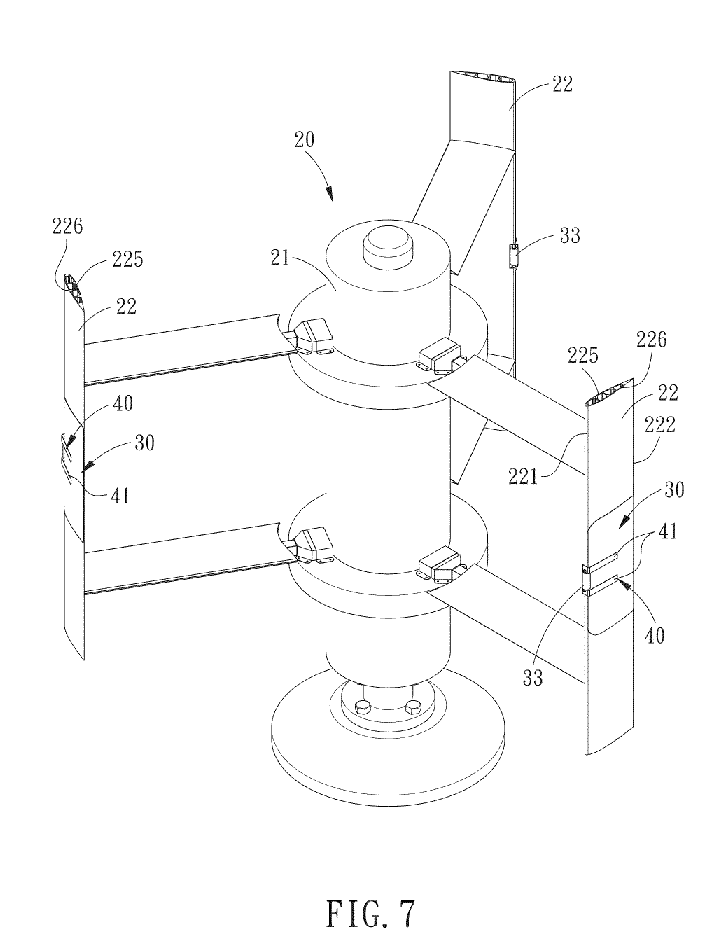

Referring to FIGS. 2 and 7 which show the device for controlling rotation speed of a vertical axis windmill by using rotating centrifugal force of rotor blades in accordance with the present invention, wherein the vertical axis windmill 20 is Darrieus windmill, and the rotor blades 22 can be arch-shaped (egg beater type) as shown in FIG. 2, or can be straight vertical (H-shaped), as shown in FIG. 7, each of the plates 30 is mounted on the leading edge 221 of the Darrieus rotor blades 22 with the pivot 33 arranged in parallel with the rotary shaft 21 of the vertical axis windmill 20.

What mentioned above are the structural relations of the main parts of the device of the present invention, for a better understanding of the operation and function of the present invention, please refer to the following descriptions.

The present invention also provides a method for controlling rotation speed of a vertical axis windmill by using rotating centrifugal force of blades, wherein the vertical axis windmill 20 comprises the rotary shaft 21 and the plurality of rotor blades 22 mounted on the rotary shaft 21. Each of the rotor blades 22 includes a leading edge 221 and a trailing edge 222. The method comprises the following steps:

a. forming the rotor blades: mounting the plates 30 and the lift control devices 40 on the rotor blades 22 in such a manner that the pivot 33 at the pivot end 31 of each of the plates 30 is pivoted to the leading edge 221 of a corresponding one of the rotor blades 22 and arranged in parallel to the rotary shaft 21 of the vertical axis windmill 20, the free end 32 of each of the plates 30 extends toward the trailing edge 222 of the corresponding one of the rotor blades 22, and the lift control devices 40 provide an elasticity Fₚ to press the corresponding plates 30 against the rotor blades 22.

b. rotation of the rotor blades: the rotary shaft 21 of the vertical axis windmill 20 rotates the rotor blades 22 to produce a centrifugal force Fᵢ on the plates 30 to push the plates 30 against the lift control devices 40, and the elasticity Fₚ counteracts the centrifugal force Fᵢ.

c. lift control: increasing the rotation speed of the rotary shaft 21 of the vertical axis windmill 20 until the centrifugal force Fᵢ is larger than the elasticity Fₚ, so that the free ends 32 of the plates 30 will pivot away from the surface of the rotor blades 22 to change the lift of the rotor blades 22 and break the rotation inertia of the rotor blades 22, and consequently slowing down the rotation speed of the rotary shaft 21 of the vertical axis windmill 20.

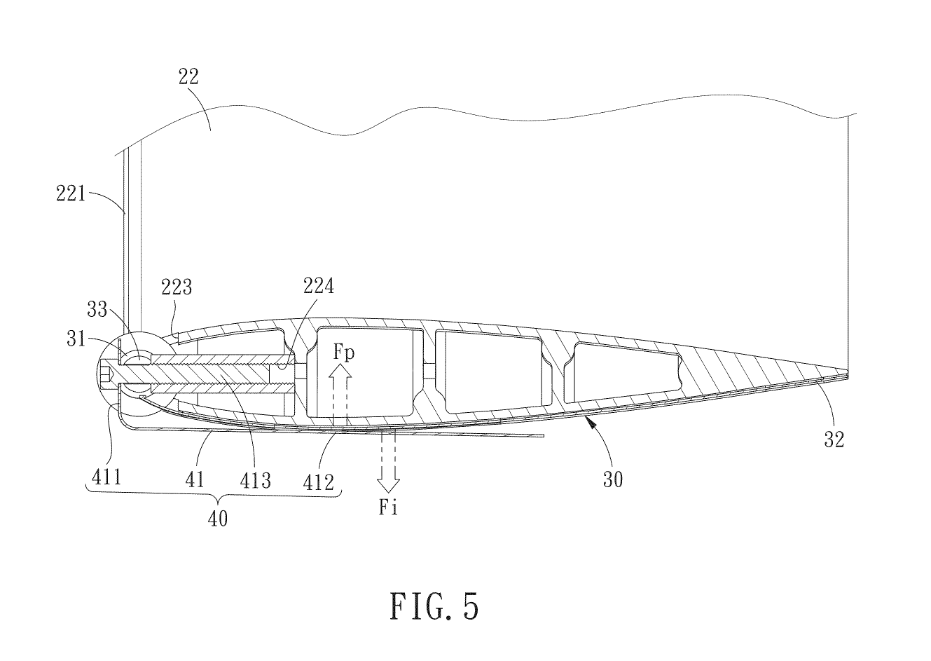

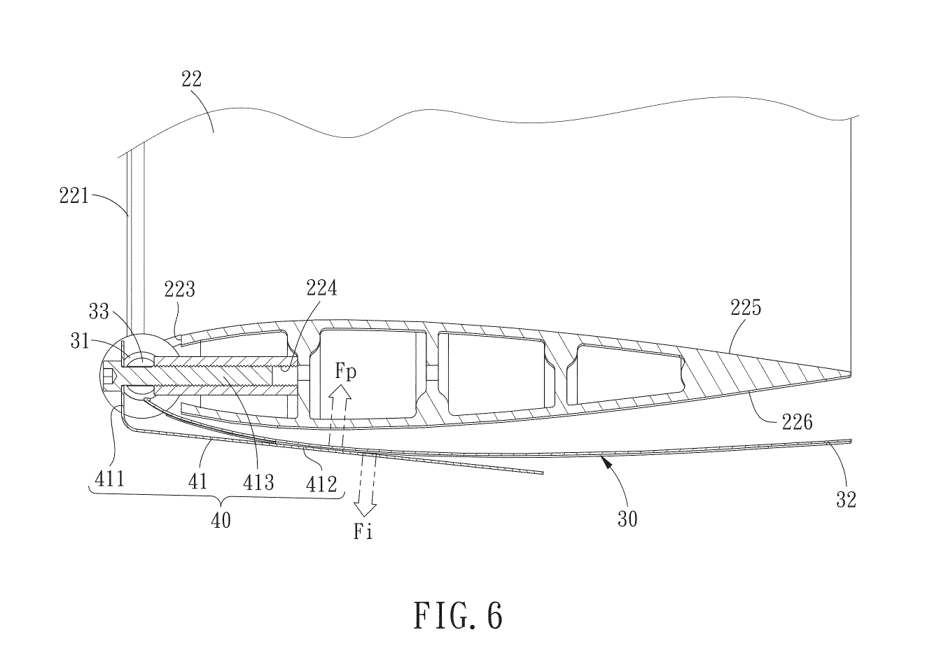

Referring to FIG. 5, the rotary shaft 21 drives the rotor blades 22 to rotate, and the rotation of the rotor blades 22 will produce a centrifugal force Fᵢ on the plates 30 to make the plates 30 pivot away from the surface of the rotor blades 22. The centrifugal force Fᵢ in the initial stage is smaller than the elasticity Fₚ. When the centrifugal force Fᵢ becomes larger than the elasticity Fₚ as the rotation speed of the rotary shaft 21 increases, as shown in FIG. 6, the free end 32 of the plates 30 will pivot away from the surface of the rotor blades 22 along with the pivot 33, so as to change the aerofoil cross section of the rotor blades 22, and as a result, the lift and rotation inertia of the rotor blades 22 will be changed to slow down the rotation speed of the rotary shaft 21 of the vertical axis windmill 20.

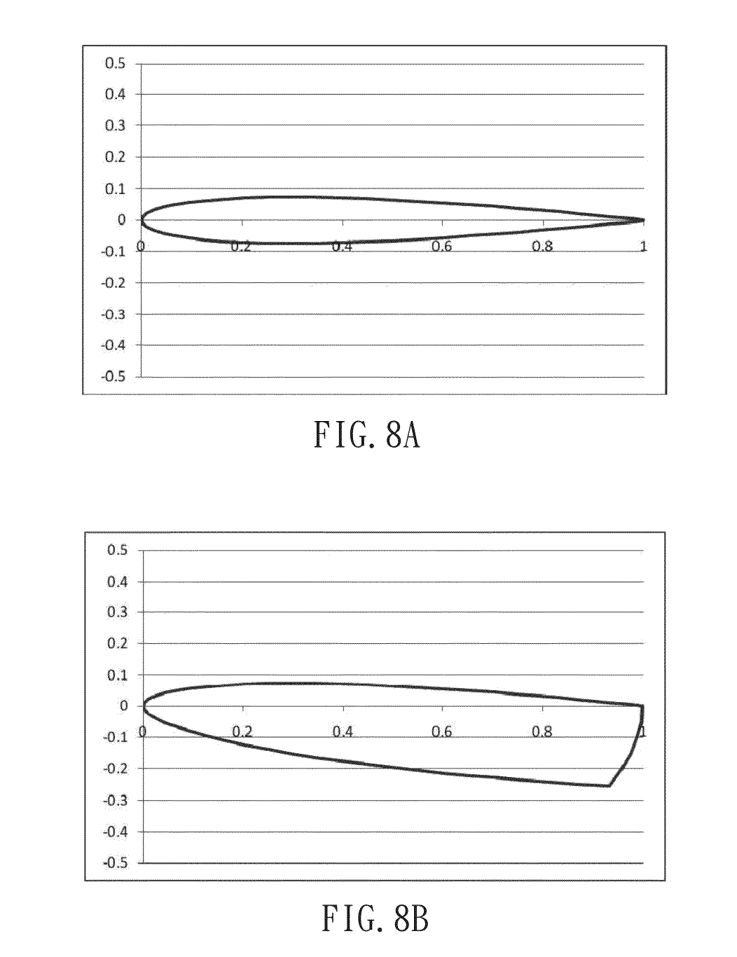

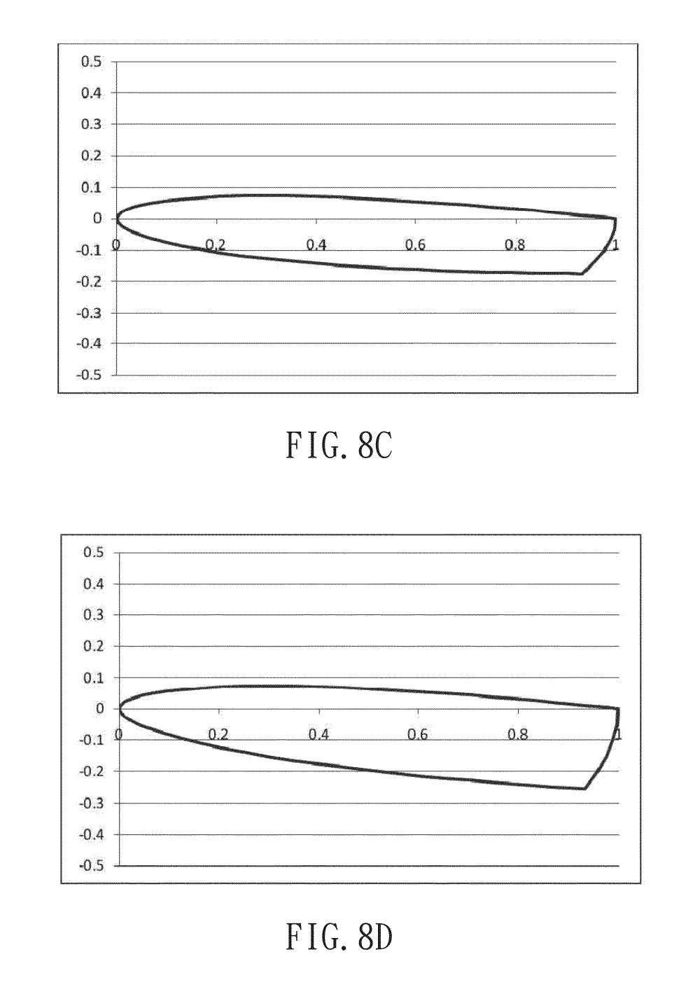

Referring to FIGS. 8A to 8D, according to the method for controlling rotation speed of a vertical axis windmill of the present invention and based on the lift principle, the leading edge 221 of each of the rotor blades 22 is provided with a corresponding plate 30 and a lift control device 40 which are located at a position in parallel with the rotary shaft 21, so that the rotor blades 22 of the vertical axis windmill 20 at a normal speed have an aerofoil cross section as shown in FIG. 8A (take NACA0015 blade as an example). When the rotation speed of the vertical axis windmill 20 is too fast, the centrifugal force Fᵢ exerted on the plate 30 will become larger than the elasticity Fₚ of the lift control unit 40 to push the plate 30 away from the surface of the rotor blade 22. When pivoting away from the rotor blade 22 to open an angle of 5, 10 or 15 degrees with respect to the rotor blade 22, the plate 30 will have the corresponding aerofoil cross section as shown in FIGS. 8B, 8C or 8D.

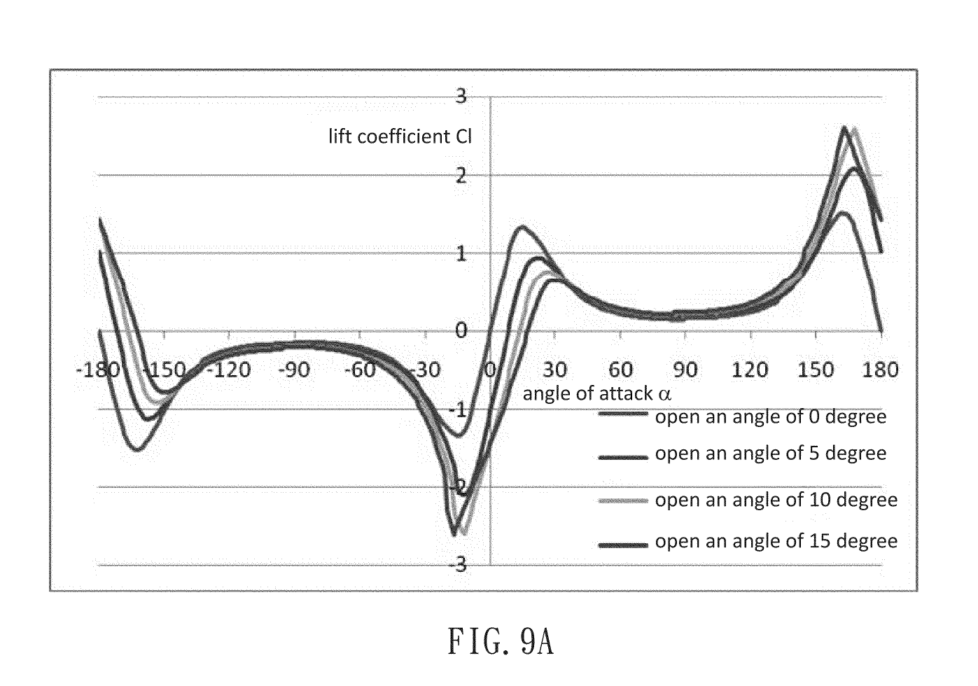

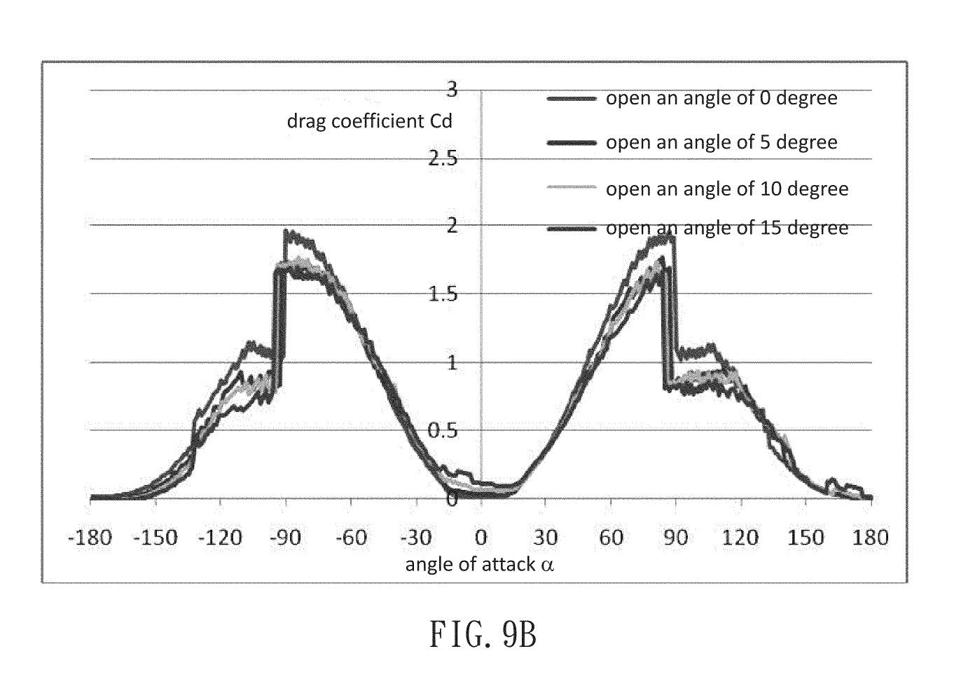

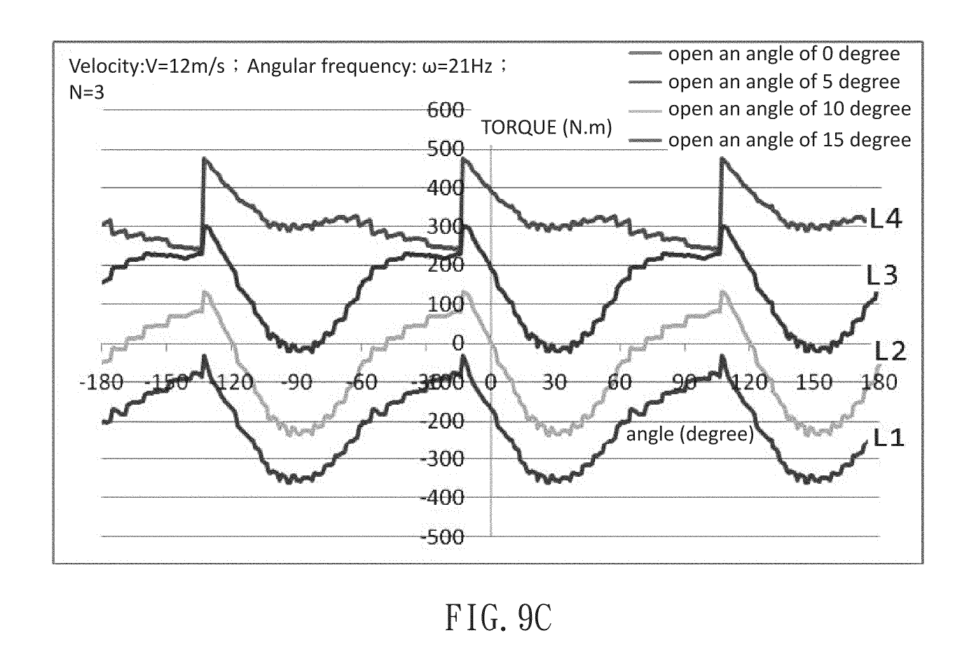

At this moment, the lift and drag of the rotor blade 22 will change along with the aerofoil cross section change, as shown in FIGS. 9A and 9B, the relations among the lift coefficient (Cl), the drag coefficient (Cd) and angle of attack (α) of the rotor blade 22 will change with the aerofoil cross section change (the negative lift increases while the drag force slightly reduces). As shown in FIG. 9C, the resultant force of the lift and the drag of each of the rotor blades 22 in a direction tangent to the rotating direction produces a negative lift which will counteract the positive lift produced by the aerofoil cross section of the rotor blade 22 in the initial stage to produce a braking function. For example, as shown in FIG. 8D, when the angle between the plate 30 and the rotor blade 22 is 15 degrees, the resultant negative lift torque is as shown by the lowest curve in FIG. 9C, wherein the maximum negative lift torque is −350 N.m. When the negative lift torque is approximately as much as 200 N.m, the plate 30 will open to slow down the rotary shaft 21 of the vertical axis windmill 20 will slow down, so that the negative lift torque counteracts the positive lift torque to make the vertical axis windmill 20 rotate at a constant speed. Hence, the overspeed problem of the windmill is solved. As shown in FIG. 9B, it seems that there is no correlation between the value of the angle between the plate 30 and the rotor blade 22 and the drag. Changing the value of the lift torque is capable of controlling the rotation speed of the vertical axis windmill 20.

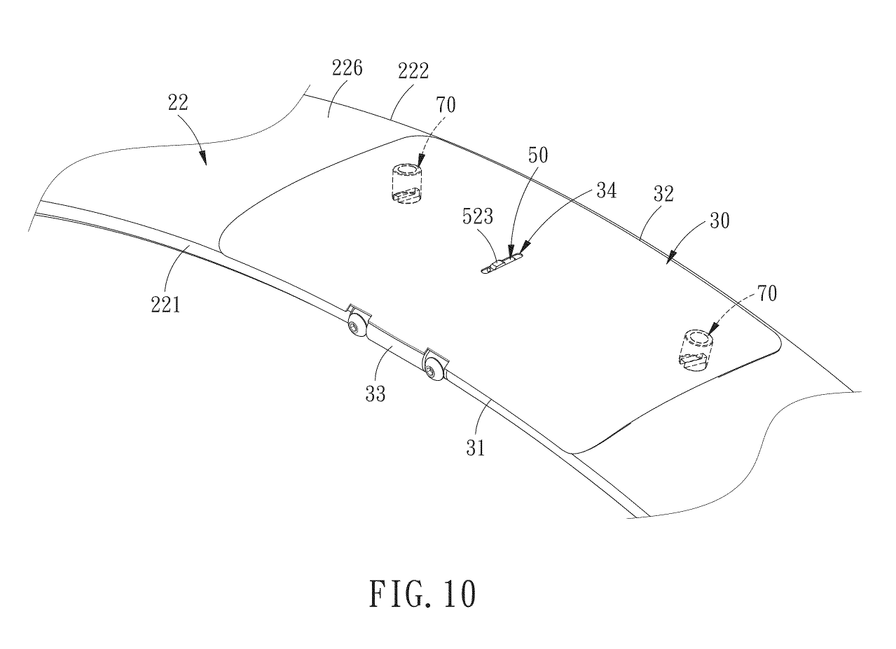

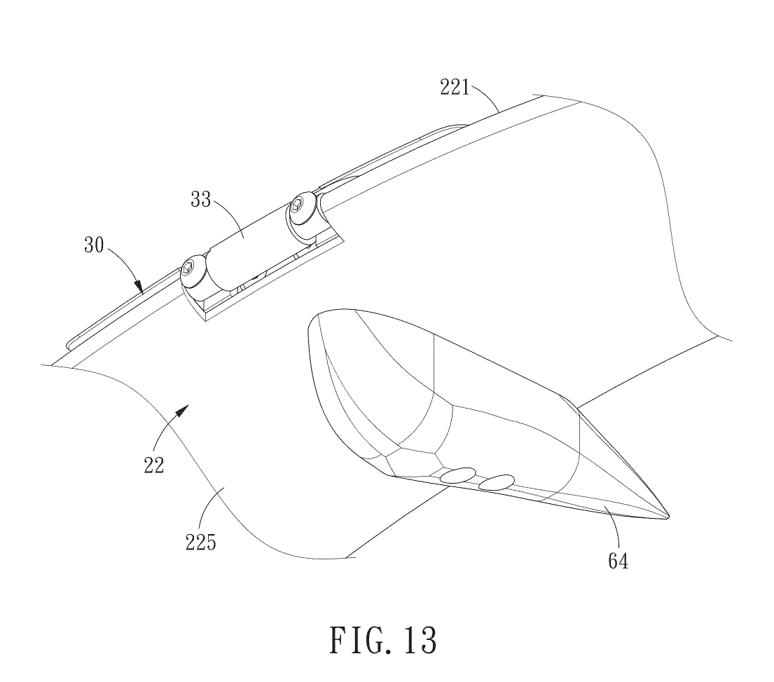

It is to be noted that the lift control device of the present invention can be a spring structure. The lift control devices 50 and 60 each include a spring 52, 63 with one end fixed in the rotor blade 22 and another end fixed to the plate 30, to provide an elasticity Fₚ to press the corresponding plates 30 against the surface of the rotor blades 22. FIGS. 10-14 show various embodiments of the lift control devices 50 and 60.

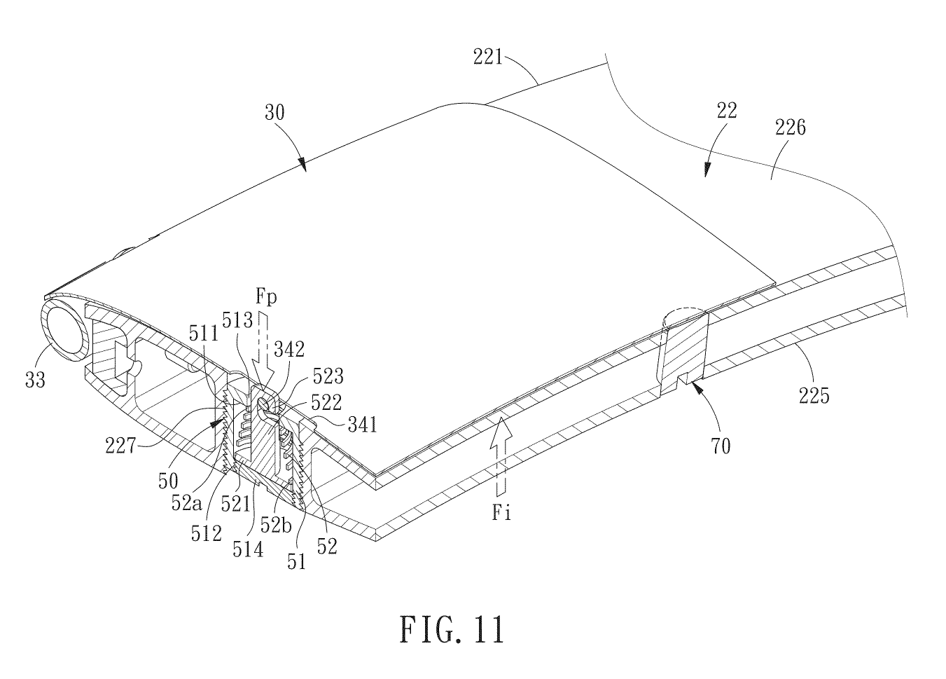

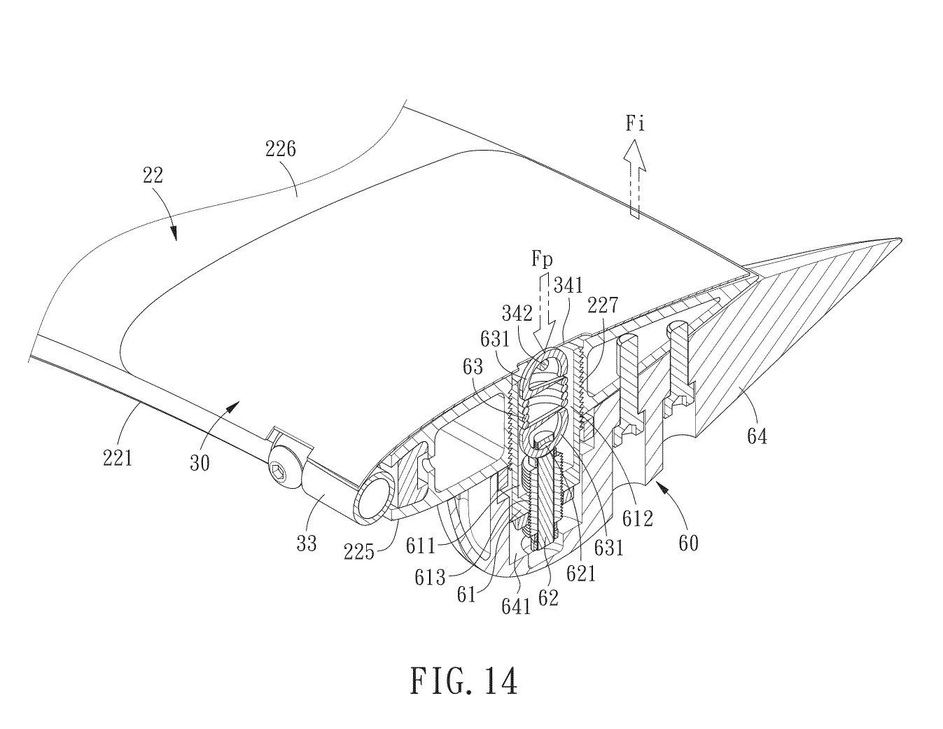

As shown in FIGS. 11 and 14, each of the rotor blades 22 is formed with an assembling hole 227 running through the inner and outer surfaces 225, 226 of the rotor blade 22. Each of the plates 30 is provided with an assembling portion 34 which is formed with a penetrating hole 341 and an engaging block 342 straddling the penetrating hole 341. The lift control devices 50 and 60 each include an engaging member 51, 61 screwed in the assembling hole 227 of the corresponding rotor blades 22, and the engaging member 51, 61 is formed with an inner space 511, 611 and an inserting hole 513, 612 in communication with the inner space 511, 611. The lift control devices 50 and 60 each further include a spring 52, 63 with one end fixed in the inner space 511, 611 and another end inserted through the inserting hole 513, 612 and fixed to the assembling portion 34 of the corresponding plate 30. The spring 52, 63 provide an elasticity Fₚ to press the corresponding plate 30 against the outer surface 226 of the rotor blade 22. When the centrifugal force Fᵢ generated by the rotation of the vertical axis windmill 20 becomes larger than the elasticity Fₚ provided by the springs 52, 63, the plates 30 will pivot away from the surface of the rotor blades 22, so as to change the lift of the surface of the rotor blades 22, and as a result, the lift and rotation inertia of the rotor blades 22 will be changed to slow down the rotation speed of the rotary shaft 21 of the vertical axis windmill 20.

As shown in FIGS. 10 and 11, the inner space 511 of the engaging member 51 of each of the lift control devices 50 is provided with an opening 512 and a cover 514, and the opening 512 is formed at the bottom of the inner space 511. The spring 52 is a conical spring with a first end 52a and a second end 52b which is larger in diameter than the first end 52a. A seat 521 is located at the second end 52b of the spring 52 and received in the inner space 511. A driven shaft 522 extends from the center of the seat 521 toward the first end 52a and is inserted in the spring 52. At the end of the driven shaft 522 is formed a hook portion 523 which is inserted through the penetrating hole 341 of the assembling portion 34 of the corresponding plate 30 and hooked to the engaging block 342. Furthermore, on the outer surface 226 of each of the rotor blades 22 is provided a plurality of magnetic members 70 to attract the plates 30 to the rotor blades 22.

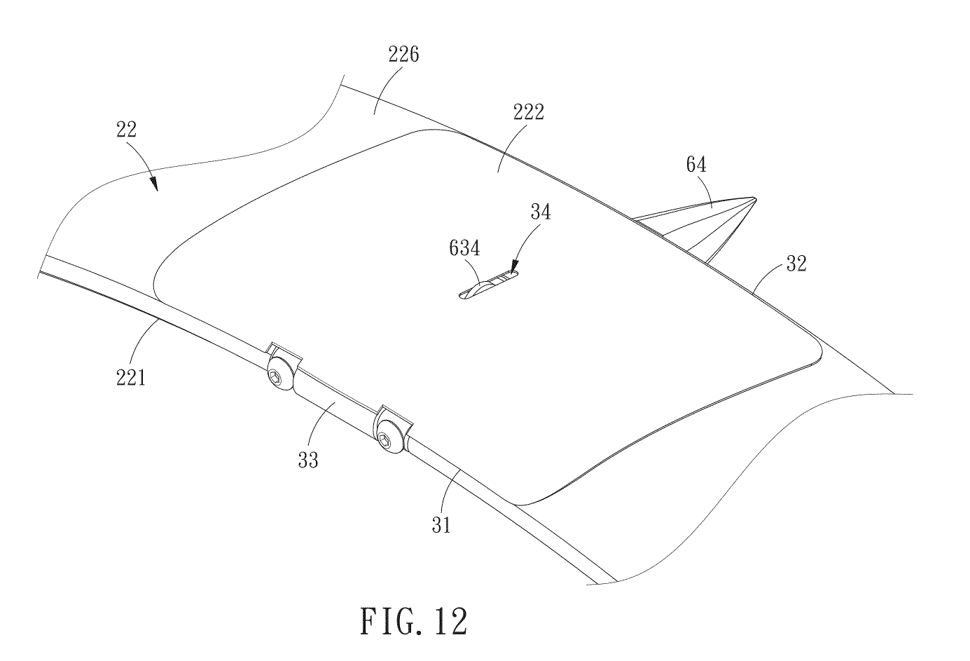

As shown in FIGS. 12-14, at the bottom of the inner space 611 of the engaging member 61 of each of the lift control devices 60 is formed a through hole 613 for insertion of a positioning shaft 62. The spring 63 is a conical spring with two hooked ends 631, one hooked end 631 hooked to a retaining hole 621 formed at one end of the positioning shaft 62, and another hooked end 631 is inserted through the inserting hole 612 of the engaging member 61 into the penetrating hole 341 of the assembling portion 34 of the plate 30 and hooked to the engaging block 342. A streamline wind shield 64 is formed with an inner chamber 641 to cover the positioning shaft 62 and the through hole 613 of the engaging member 61. The wind shield 64 is fixed to the rotor blades 22 and streamlined to reduce the drag caused by the engaging member 61 and the positioning shaft 62 protruding out of the surface of the rotor blades 22.

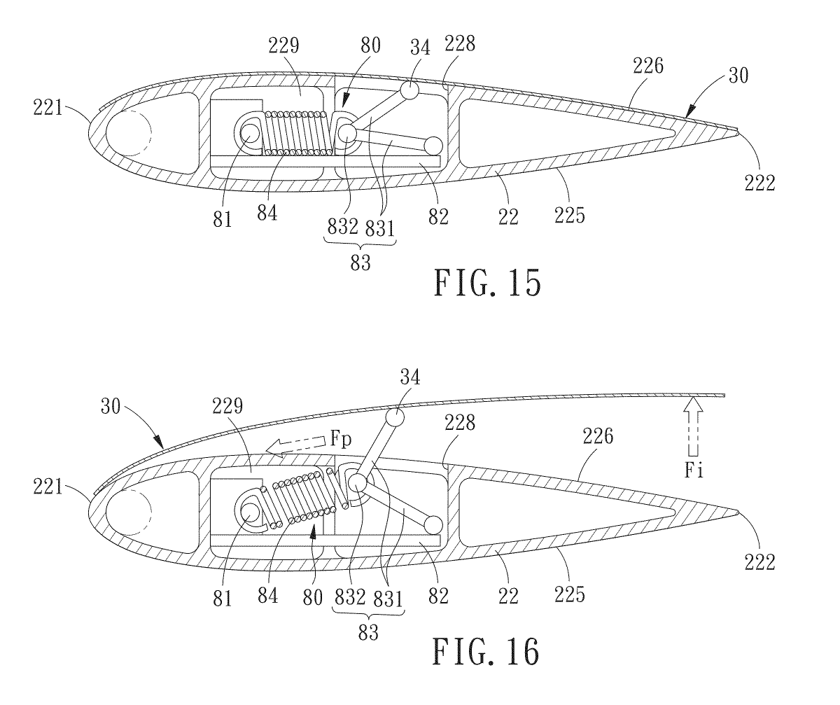

FIG. 15 shows another embodiment of the lift control device 80 of the present invention, wherein the outer surface 226 of each of the rotor blades 22 is formed with an inserting hole 228 which is in communication with an inner space 229 formed inside the corresponding rotor blades 22. The inner space 229 extends along the direction along which the leading and trailing edges 221, 222 of the rotor blades 22 extend. The inner space 229 of each of the rotor blades 22 is provided at one end thereof adjacent to the trailing edge 222 with a positioning pivot portion 81. At a side of the positioning pivot portion 81 adjacent to the inner surface 225 of the concerned rotor blade 22 is disposed a pivot member 82 which extends toward the trailing edge 222. A linkage device 83 includes two rods 831 pivoted to each other at a pivot point 832. The linkage device 83 has one end pivoted at one end of one of the two rods 831 and another end pivoted to the assembling portion 34 of the plate 30. The spring 84 is a conical spring with two ends pivoted to the positioning pivot portion 81 and the pivot point 832, respectively. As shown in FIG. 16, the spring 84 is arranged along the extending direction of the inner space 225, so that the extension distance of the spring 84 is increased t, and when the plate 30 opens (pivots away from) the surface of the rotor blade 22, it will produce more drag to slow down the rotation speed of the vertical axis windmill 20.

While we have shown and described various embodiments in accordance with the present invention, it is clear to those skilled in the art that further embodiments may be made without departing from the scope of the present invention.

What is claimed is:

1. A method for controlling rotation speed of a vertical axis windmill by using rotating centrifugal force of rotor blades, comprising the following steps:
a, mounting a plate and a lift control device on each of the rotor blades in such a manner that a pivot at a pivot end of the plate is pivoted to a leading edge of each of the rotor blades and arranged in parallel to a rotary shaft of the vertical axis windmill, a free end of the plate extends toward a trailing edge of each of the rotor blades, and the lift control device provides an elasticity to press the plate against each of the rotor blades;
b, the rotary shaft of the vertical axis windmill rotating the rotor blade to produce a centrifugal force on the plate to push the plate against the lift control device, and the elasticity counteracting the centrifugal force; and
c, increasing the rotation speed of the rotary shaft of the vertical axis windmill until the centrifugal force is larger than the elasticity, so that the free end of the plate will pivot away from the rotor blades to change a lift of the rotor blades and break a rotation inertia of the rotor blades, and consequently slowing down the rotation speed of the rotary shaft of the vertical axis windmill.

2. The method as claimed in claim 1, wherein the lift control device includes two elastic pressing pieces disposed on each of the rotor blades to provide an elasticity pushing the plate against the lift control device.

3. The method as claimed in claim 1, wherein the lift control device includes a spring with one fixed in each of the rotor blades and another end fixed to the plate, to provide an elasticity to press the plate against the rotor blades.

4. A device for controlling rotation speed of a vertical axis windmill by using rotating centrifugal force of rotor blades, the vertical axis windmill comprising a rotary shaft and a plurality of the rotor blades mounted on the rotary shaft, each of the rotor blades being provided at a leading edge thereof with a plate and a lift control device; wherein:
each of the rotor blades includes the leading edge and a trailing edge, between the leading edge and the trailing edge of each of the rotor blades are an inner surface located toward the rotary shaft and an outer surface opposite the inner surface;
the plate is mounted on the outer surface of the respective rotor blades and includes a pivot end and a free end, the pivot end is pivoted to the leading edge of the rotor blades via a pivot, and the free end extends rearward toward the trailing edge;
the lift control device includes two elastic pressing pieces disposed at two ends of the pivot, and each of the elastic pressing pieces includes a fixing portion fixed at the leading edge of each of the rotor blades and a pressing portion extending rearward toward the trailing edge, the pressing portions of the two elastic pressing pieces have an elasticity to press against the free end of the plate; and
the vertical axis windmill rotates to provide a centrifugal force to the plate, and when the centrifugal force is larger than the elasticity, the free end of the plate will pivot away from a surface of the rotor blades along with the pivot, so that a lift and rotation inertia of the rotor blades will be changed to slow down the rotation speed of the rotary shaft of the vertical axis windmill.

5. The device for controlling rotation speed of a vertical axis windmill as claimed in claim 4, wherein the leading edge of each of the rotor blades is provided with a receiving cavity which is located at a position in parallel with the rotary shaft, and the pivot end of the plate takes the form of a hollow sleeve structure pivotally sleeved on the pivot;
two fasteners are inserted through the fixing portions of the two elastic pressing pieces of each of the lift control devices and screwed into two locking holes of each of the rotor blades.

6. The device for controlling rotation speed of a vertical axis windmill as claimed in claim 4, wherein on the outer surface of each of the rotor blades is provided a plurality of magnetic members to attract the plates to the rotor blades.

7. The device for controlling rotation speed of a vertical axis windmill as claimed in claim 4, wherein the rotor blades are Darrieus blades.

8. A device for controlling rotation speed of a vertical axis windmill by using rotating centrifugal force of rotor blades, the vertical axis windmill comprising a rotary shaft and a plurality of the rotor blades mounted on the rotary shaft, each of the rotor blades being provided at a leading edge thereof with a plate and a lift control device; wherein:
each of the rotor blades includes the leading edge and a trailing edge, between the leading edge and the trailing edge are an inner surface and an outer surface, the outer surface of each of the rotor blades is formed with an inserting hole which is in communication with an inner space formed inside the rotor blades;
the plate includes a pivot end and a free end, the pivot end is pivoted to the leading edge of the rotor blades via a pivot, and the free end extends rearward toward the trailing edge, the plate is provided with an assembling portion;
the lift control device includes a spring with one end fixed in the inner space of the rotor blades and another end fixed to the plate via the inserting hole, to provide an elasticity to press the plate against the rotor blades; and
the vertical axis windmill rotates to provide a centrifugal force to the plate, and when the centrifugal force is larger than the elasticity, the free end of the plate will pivot away from a surface of the rotor blades along with the pivot, so that a lift and rotation inertia of the rotor blades will be changed to slow down the rotation speed of the rotary shaft of the vertical axis windmill.

9. The device for controlling rotation speed of a vertical axis windmill as claimed in claim 8, wherein each of the rotor blades is formed with an assembling hole running through the inner and outer surfaces of the rotor blades;
the assembling portion of the plate is formed with a penetrating hole and an engaging block straddling the penetrating hole;
the lift control device includes an engaging member screwed in the assembling hole of the rotor blades, and the engaging member is formed with an inner space and an inserting hole in communication with the inner space, the spring is a conical spring with a first end and a second end which is larger in diameter than the first end, a seat is located at the second end of the spring and received in the inner space, a driven shaft extends from a center of the seat toward the first end and is inserted in the spring, at one end of the driven shaft is formed a hook portion which is inserted through the penetrating hole of the assembling portion of the plate and hooked to the engaging block.

10. The device for controlling rotation speed of a vertical axis windmill as claimed in claim 8, wherein each of the rotor blades is formed with an assembling hole running through the inner and outer surfaces of the rotor blades;
the assembling portion of the plate is formed with a penetrating hole and an engaging block straddling the penetrating hole;
the lift control device includes an engaging member screwed in the assembling hole of the rotor blades, and the engaging member is formed with an inner space, at a bottom of the inner space of the engaging member is formed a through hole for insertion of a positioning shaft, the spring is a conical spring with two hooked ends, one of the hooked ends is hooked to a retaining hole formed at one end of the positioning shaft, and another of the hooked ends is inserted through the inserting hole of the engaging member into the penetrating hole of the assembling portion of the plate and hooked to the engaging block, a streamline wind shield is formed with an inner chamber to cover a positioning shaft and a through hole of the engaging member.

11. The device for controlling rotation speed of a vertical axis windmill as claimed in claim 8, wherein the inner space of the rotor blades extends along a direction along which the leading and trailing edges of the rotor blades extend, the inner space of each of the rotor blades is provided at one end thereof adjacent to the trailing edge with a positioning pivot portion, at a side of the positioning pivot portion adjacent to the inner surface of each of the rotor blades is disposed a pivot member which extends toward the trailing edge, a linkage device includes two rods pivoted to each other at a pivot point, the linkage device has one end pivoted at one end of one of the two rods and another end pivoted to the assembling portion of the plate, the spring is a conical spring with two ends pivoted to the positioning pivot portion and the pivot point, respectively.

12. The device for controlling rotation speed of a vertical axis windmill as claimed in claim 8, wherein on the outer surface of each of the rotor blades is provided a plurality of magnetic members to attract the plates to the rotor blades.

13. The device for controlling rotation speed of a vertical axis windmill as claimed in claim 8, wherein the rotor blades are Darrieus blades.

14. The device for controlling rotation speed of a vertical axis windmill as claimed in claim 13, wherein the rotor blades are straight and vertical Darrieus blades.

15. The device for controlling rotation speed of a vertical axis windmill as claimed in claim 13, wherein the rotor blades are arch-shaped Darrieus blades.
